(19) United States
(12) Patent Application Publication
(10) Pub. No.: US 2023/0230127 A1
(43) Pub. Date: Jul. 20, 2023

(54) METHOD AND APPARATUS FOR EVALUATING CUSTOMER INTERACTIONS

(71) Applicant: Dell Products L.P., Round Rock, TX (US)

(72) Inventors: Walter Cristian Bruck Mundstock, Edison, NJ (US); Nirmala D'Souza, Austin, TX (US); João Francisco Homrich da Jornada, Porto Alegre (BR)

(73) Assignee: Dell Products L.P., Round Rock, TX (US)

(21) Appl. No.: 17/648,028

(22) Filed: Jan. 14, 2022

(51) Int. Cl. G06Q 30/02

(52) U.S. Cl. CPC G06Q 30/0255; G06Q 30/0201; G06Q 30/0204; G06Q 30/0271

(57) ABSTRACT

A method is provided, comprising: identifying a plurality of communications sessions and obtaining a respective transcript of each of the plurality of communications sessions, each of the plurality of communications sessions involving a respective one of a plurality of customers; generating a plurality of label sets, each of the label sets corresponding to a different one of the plurality of customers; generating a plurality of customer signatures, each of the plurality of customer signatures being generated based on a different one of the plurality of label sets; classifying, with a first neural network, each of the plurality of customer signatures into one of a “re-engage” category and a “do-not-re-engage” category; and returning a customer re-engagement list that identifies respective ones of the plurality of customers who are associated with customer signatures that are classified in the “re-engage” category.

### BACKGROUND

Customers may interact with a company through several different channels, such as on line chat, social media platforms, voice channels, or video channels. Each of these channels offers customers a unique experience and customers may choose a particular channel based on their preference, the complexity of the issue they would like to discuss with an agent, or ease of use of the channel. A company must constantly keep up with new channels of communication that become available and provide its customers with the flexibility to choose a communications channel of their liking.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided, comprising: identifying a plurality of communications sessions and obtaining a respective transcript of each of the plurality of communications sessions, each of the plurality of communications sessions involving a respective one of a plurality of customers; generating a plurality of label sets, each of the label sets corresponding to a different one of the plurality of customers, each of the plurality of label sets being generated based, at least in part, on the respective transcript of one of the plurality of communications sessions that involves the label set’s corresponding customer; generating a plurality of customer signatures, each of the plurality of customer signatures being generated based on a different one of the plurality of label sets; classifying each of the plurality of customer signatures into one of a “re-engage” category and a “do-not-re-engage” category, the classification being performed by using a first neural network; and returning a customer re-engagement list that identifies respective ones of the plurality of customers who are associated with customer signatures that are classified in the “re-engage” category.

According to aspects of the disclosure, a system is provided, comprising: a memory; and at least one processor that is operatively coupled to the memory, the at least one processor being configured to perform the operations of: identifying a plurality of communications sessions and obtaining a respective transcript of each of the plurality of communications sessions, each of the plurality of communications sessions involving a respective one of a plurality of customers; generating a plurality of label sets, each of the label sets corresponding to a different one of the plurality of customers, each of the plurality of label sets being generated based, at least in part, on the respective transcript of one of the plurality of communications sessions that involves the label set’s corresponding customer; generating a plurality of customer signatures, each of the plurality of customer signatures being generated based on a different one of the plurality of label sets; classifying each of the plurality of customer signatures into one of a “re-engage” category and a “do-not-re-engage” category, the classification being performed by using a first neural network; and returning a customer re-engagement list that identifies respective ones of the plurality of customers who are associated with customer signatures that are classified in the “re-engage” category.

According to aspects of the disclosure, a method is provided, comprising: retrieving customer interaction information that is associated with a customer, the customer interaction information including a transcript of a communications session involving the customer; generating a plurality of labels for the customer based on the customer interaction information, at least one of the plurality of labels being generated based on a transcript associated with the customer; generating a customer signature for the customer, the customer signature being generated based on the plurality of labels; and classifying the customer signature into one of a plurality of categories, the plurality of categories including one or more first categories and one or more second categories, the classification being performed, at least in part, by using a first neural network; and transmitting a re-engagement communication to the customer based on an outcome of the classification of the customer signature for the customer, the re-engagement communication being transmitted only when the customer signature is classified into the one or more first categories.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of a lead identification system 108, according to aspects of the disclosure;

FIG. 3A is a diagram of an example of a metadata database, according to aspects of the disclosure;

FIG. 3B is a diagram of an example of a label, according to aspects of the disclosure;

FIG. 3C is a diagram of an example of a label, according to aspects of the disclosure;

FIG. 3D is a diagram of an example of a label, according to aspects of the disclosure;

FIG. 3E is a diagram of an example of a label, according to aspects of the disclosure;

FIG. 3F is a diagram of an example of a customer signature, according to aspects of the disclosure;

FIG. 4A is a flowchart of an example of a process, according to aspects of the disclosure;

FIG. 4B is a flowchart of an example of a process, according to aspects of the disclosure;

FIG. 5 is a flowchart of an example of a process, according to aspects of the disclosure;

FIG. 6 is a diagram of an example of a computing system, according to aspects of the disclosure.

### DETAILED DESCRIPTION

An interaction between a customer and an agent of a company may cause the company to view the customer as a hot lead. In some industries, an interaction between a customer and an agent results in a sale 40% of the time. So, in essence, 60% of the time there are customers who have shown sufficient interest in buying a product so as to talk with an agent, but who have decided not to purchase for some reason. In some respects, at least a portion of those customers can be caused to change their minds and make a purchase if re-engaged. So, re-engaging with these customers is an important aspect of the sales process.

The present disclosure provides a method and system for identifying leads among customers who have been engaged in an online chat or a voice call with an agent of a company. As is discussed further below, the method and system use artificial intelligence (AI) to learn on successful interactions and determine factors that predict with a high degree of confidence those customers that could be re-engaged to close a sale. Re-engagement may be conducted through SMS or email messages that demonstrate the company’s commitment to meeting customer needs. In other words, the method and system identify (i) customers who have been engaged previously and are expected to make a purchase if re-engaged, and distinguishes those customers from (ii) other customers who have been engaged previously but are not expected to make a purchase if re-engaged.

In one aspect, the method and system automatically re-engage with customers by dynamically evaluating online customer interactions on transactional sales interactions. The method and system may use a combination of techniques like AI/ML tools, ETL, or data processing. Reengaging with customers in highly transactional environments where customers have unlimited choice and flexibility is critical to increasing market share. These engagements must be personal and targeted so as to not ‘turn off’ the customer with communications that look generic. For companies that have millions of dollars in sales revenue, re-engagement and conversion of even a few percentage points will result in multi-million dollars in revenue.

One advantage of the method and system is that they may prevent, from being contacted, customers who have been engaged previously but are unlikely to make a purchase. Contacting such customers, not only may fail to result in a purchase, but it could also annoy the customers and create a negative will, thus discouraging the customers from purchasing in the future. In other words, the method and system may help increase customer satisfaction among customers who have been engaged but are currently not ready to make a purchase.

Another advantage of the method and system is that they may increase the efficiency at which agents operate. During limited-duration sales campaigns, such as Black Friday, it may be challenging for a team of agents to re-engage with every one of the customers who have been engaged previously; this is especially so when a large number of customers have been engaged and the sales campaign has a short duration. Accordingly, selecting for re-engagement only customers who are likely to make a purchase can increase the rate at which sales are made during the sales campaign and increase the net proceeds from the sales campaign.

Yet another advantage of the method and system is that they can be utilized in conjunction with one-off interactions with a customer, where a detailed record of past purchases or quotes (which are unrelated to the one-off interaction) is not available. As is discussed further below, the method and system may perform natural language processing on the transcript of a voice call or a chat session to identify information that is indicative of whether a customer is likely to make a purchase.

Yet another advantage of the method and system is that they provide a structured approach towards customer re-engagement. Online interactions with a customer typically are tracked through browsing history or shopping carts. But offline interactions through Voice or Chat channels are harder to be leveraged for re-engagement. Re-engagement, if it occurs, is because an agent has taken notes and then follows up personally with the customer. These interactions become subjective and follow-ups may be sporadic based on the personal gut feel of the agent regarding possibility of a successful sales conversion, or based on time constraints for a timely re-engagement.

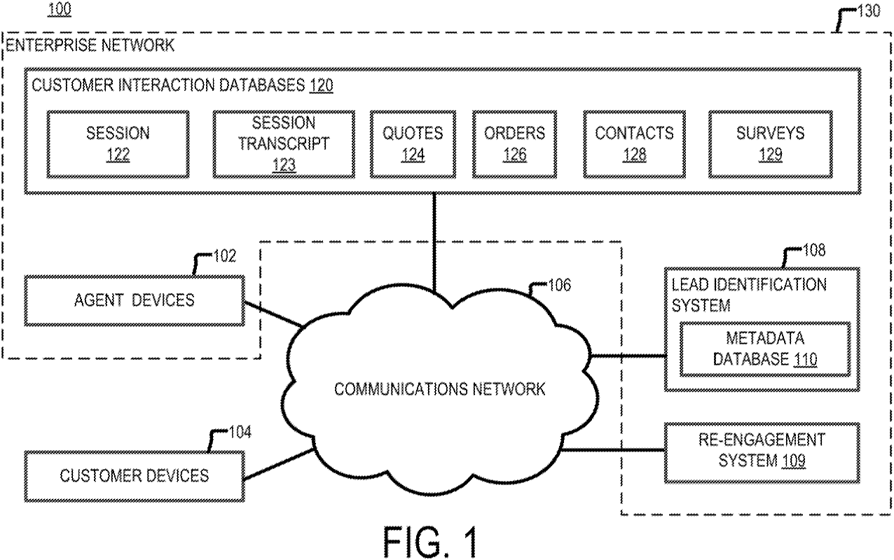

FIG. 1 is a diagram of an example of a system 100, according to aspects of the disclosure. As illustrated, the system 100 may include one or more agent devices 102, one or more customer devices 104, a lead identification system 108, a re-engagement system 109, and one or more databases 120. According to the present example, the devices 102, the devices 104, the system 108, the system 109, and the databases 120 may be coupled to one another via a communications network 106. The communications network 106 may include one or more of a local area network (LAN), a wide area network (WAN), a cellular network, the Internet, and/or any other suitable type of network. The devices 102, the databases 120, and the systems 108-109 may be part of an enterprise network 130.

The enterprise network 130 may belong to a company that specializes in selling products to customers. Agents of the company may use the agent devices 102 and customers may use the customer devices 104. The agents and customers may engage over communications sessions that are established between the devices 102 and the devices 104. Each of the communications sessions may be conducted for a customer to obtain information on a product that is being sold by the company or for any other reason. Each of the communications sessions may be a voice call, a video call, text chat, or another real-time or near-real-time communications session. Each of the devices 102 may include a laptop computer, a desktop computer, a smartphone, an analog phone, and/or any other suitable type of electronic device. Each of the devices 104 may include a laptop computer, a desktop computer, a smartphone, an analog phone, and/or any other suitable type of electronic device.

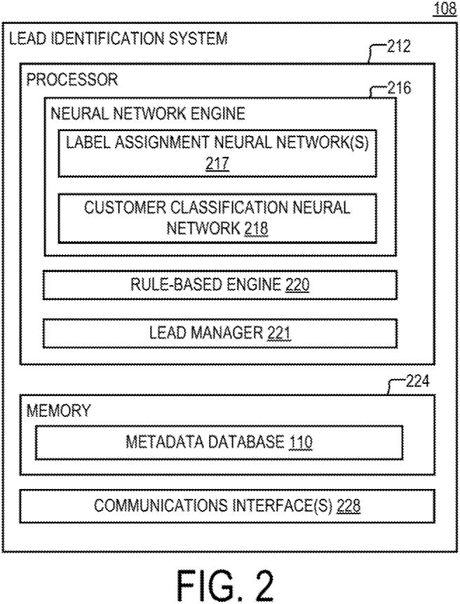

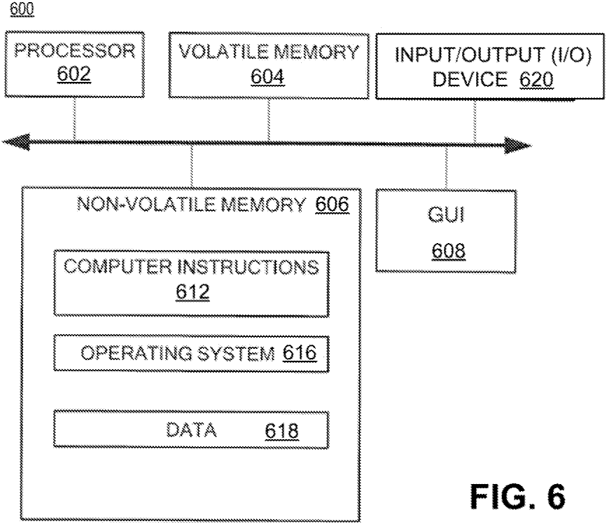

In operation, the system 108 may identify customers who have been engaged previously, and who are likely to respond positively if re-engaged (e.g., by making a purchase). The system 108 may provide a list of such customers to the re-engagement system 109. The re-engagement system may transmit a re-engagement communication to each of the customers on the list. The re-engagement communication may be a message urging the customers to make a purchase or advertising a product. The re-engagement system may include one or more computing devices, such as the computing device 600, which is discussed further below with respect to FIG. 6. Although the systems 109 and 108 are depicted as discrete entities, in some implementations they may be integral with one another. The operation of the systems 108 and 109 is discussed further below with respect to FIGS. 2-8.

The databases 120 may include one or more databases that are configured to store information associated with customer interactions. In the example of FIG. 1, the databases 120 include a session database 122, a session transcript database 123, a quotes database 124, an orders database 126, a contacts database 128, and a survey database 129. However, it will be understood that the present disclosure is not limited to any specific type of information being stored in the customer interaction databases 120.

The session database 122 may store a plurality of session identifiers. Each session identifier may correspond to a different communications session that is conducted between one of devices 102 and one of devices 104. As noted above, each communications session may include a text chat, a voice call, or a video call that is conducted between a customer and an agent.

The session transcript database 124 may store a plurality of transcripts. Each transcript may be a text transcript of a different one of the plurality of communications sessions that are identified in the session database 122. Any of the transcripts may include a log of a text chat or a transcript of a voice/video call. In the latter case, the transcript may be generated by using speech-to-text translation, either in real-time with the communications session or based on a recording of the communications session.

The quotes database 124 may store a plurality of sales quotes. Each sales quote may be a quote for the sale of a product that is provided during one of the communications sessions (identified in database 122), or at another time.

The orders database 126 may store a plurality of sales orders.

The contacts database 128 may store contact records. Each of the contact records may identify the attempts that have been made to contact a respective one of the customers who participated in the communications sessions (identified in the session database 122). In other words, the contacts database 128 may identify whether any of the customers have been re-engaged already, how many times, over what channel, and when.

The survey database 129 may store a plurality of surveys. Each of the surveys may be completed by one of the customers who participated in the communications session (identified in database 122), and it may reflect the customer’s satisfaction with the communications session or customer satisfaction in general.

As used through the disclosure, the term “database” may refer to one or more files or data structures that store information. For example, a database may be a text file, a spreadsheet, an SQL database, a NoSQL database, a directory of files, etc. In some implementations, each of the databases 122-129 may be stored in a separate server or separate sets of servers. Alternatively, any two of the databases 122-129 may be stored in the same server or the same set of servers. It will be understood that the present disclosure is not limited to any specific implementation of the databases 122-129. However, in practice, some of the databases 122-129 may be operated on completely different systems. The system 108 may mine information on isolated systems to generate labels that are associated with communications sessions. The labels that are generated for a particular communications session between an agent and a customer may be used, by the system 108, to generate a customer signature for the customer. The system 108 may then classify the customer signature in order to determine whether customer should be re-engaged.

FIG. 2 is a diagram of the system 108, according to aspects of the disclosure. As illustrated, the system 108 may include a processor 212, a memory 224, and a communications interface 228. The processor 212 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 224 may include any suitable type of volatile and/or non-volatile memory. In some implementations, the memory 224 may include one or more of a random-access memory (RAM), a dynamic random memory (DRAM), a flash memory, a hard drive (HD), a solid-state drive (SSD), a network accessible storage (NAS), and or any other suitable type of memory device. The communications interface 228 may include any suitable type of communications interface, such as one or more Ethernet adapters, one or more Wi-Fi adapters (e.g., 802.1414 adapters), and one or more Long-Term Evolution (LTE) adapters, for example.

The processor 212 may be configured to execute a neural network engine 216. The neural network engine 216 may be configured to implement one or more neural networks 217 and a neural network 218. The present disclosure is not limited to any specific implementation of any of neural networks 217 and 218. Each of the neural networks 217 and 218 may be a feed-forward network, a convolutional neural network, a recurrent neural network, and/or any other suitable type of neural network.

Each of the neural networks 217 may include a neural network that is configured to determine the value of a label. Each of the neural networks 217 may be configured to take as input a signature of a transcript of a communications session and classify the signature into one of a plurality of categories, where each of the categories, or at least some of the categories, corresponds to a respective value of the associated label. The label may be a number (or alphanumerical string) that indicates whether a particular condition is satisfied and/or how the condition is satisfied. As is discussed further below, any of the neural networks 217 may be configured to determine a customer’s mood or sentiment based on a transcript of a communications session involving the customer. As another example, any of the networks may be used to identify the party on whose initiative a condition was satisfied. As yet another example, any of the neural networks 217 may be used to identify whether a particular topic or product was discussed during a communications session, etc.

The neural network 218 may be configured to classify a customer signature into one of a “re-engage” category and a “do not re-engage” category. The re-engage category may be a category (or set of categories) associated with a heightened customer potential for making a purchase. The do-not-reengage category may be a category (or set of categories) that are associated with a lower customer potential for making a purchase. In some implementations, classifying a customer signature, with the neural network 218, into one of a re-engage category and do-not-re-engage category may include: (i) classifying the customer signature into one of a plurality of categories, the plurality consisting entirely of a first category and a second category; (ii) when the customer signature is classified in the first category, determining that the customer signature is classified in the re-engage category; and (iii) when the customer signature is classified in the second category, determining that the customer signature is classified in the do-not-re-engage category. Additionally or alternatively, in some implementations, classifying a customer signature, with the neural network 218, into one of a re-engage category and do-not-re-engage category may include: (i) classifying the customer signature into one of a plurality of categories, the plurality including one or more first categories and one or more second categories; (ii) when the customer signature is classified in any of the first categories, determining that the customer signature is classified in the re-engage category; and (iii) when the customer signature is classified in any of the second categories, determining that the customer signature is classified in the do-not-re-engage category. In other words, the classification may be performed entirely by the neural network 218, or it may involve a secondary step in which the output of the neural network needs to be interpreted to determine whether a category in which the customer signature is classified is a “re-engage” category.

The neural network 218 may be trained based on a training data set. The training data set may include a plurality of training data items (e.g., rows of data). Each training data item may include: (i) a customer signature and (ii) a training label that is generated based on whether a customer associated with the customer signature has completed a purchase following the transmission of a re-engagement communication to the customer. Alternatively, each training data item include: (i) a customer signature and (ii) a training label that is generated based on whether a customer associated with the customer signature responded positively (e.g.by demonstrating interest or asking a follow-up question), or responded at all, to a re-engagement communication that was sent to the customer. The training data may be generated based on historical records for past customer re-engagement attempts.

The neural network 218 may be tailored to a specific modality of re-engagement. For example, the neural network 218 may be trained by using (only or predominantly) historical records in which customer re-engagement was attempted by using SMS messages. As another example, the neural network 218 may be trained by using (only or predominantly) historical records in which customer re-engagement was attempted by calling the customer on the phone. As yet another example, the neural network 218 may be trained by using (only or predominantly) historical records in which customer re-engagement was attempted by sending an email message to the customer. In other words, in some implementations, the neural network 218 may be used to determine whether a specific type of communications channel (e.g., SMS or telephone call) is suitable for re-engaging a customer.

The neural network 218 may be tailored to a specific type of product. For example, the neural network 218 may be trained by using (only or predominantly) historical records in which customer re-engagement was attempted for the purpose of selling laptop computers. As another example, the neural network 218 may be trained by using (only or predominantly) historical records in which customer re-engagement was attempted for the purpose of selling a warranty service. In other words, in some implementations, the neural network 218 may be used to determine whether it makes sense to contact a customer, given the specific product which is going to be offered to the customer.

The neural network 218 may be trained to find leads for specific marketing campaigns (or specific re-engagement campaigns). For example, a marketing campaign (or a re-engagement campaign) may involve reaching out to customers via SMS and offering the customers a specific product (e.g., a laptop computer). In such implementations, the neural network 218 may be trained in a manner that is tailored towards the specific channel of the campaign (e.g., SMS) and the specific product that is being offered. Afterwards, the neural networks may classify the customer signatures of different customers to determine which ones of them are good candidates for receiving SMS messages that are transmitted as part of the campaign. In general, customers whose signatures are classified in a “re-engage” category may be selected to receive the SMS messages, while customers who are classified in the do-not-re-engage category would not receive the SMS messages.

In some implementations, the neural network 218 may be weighted in favor of classifying, in the re-engage category, customers who are determined to have been in a good mood during the initial engagement. The mood of customers may be inferred by the neural network 218 from the values of labels, such as CUSTOMER_MOOD and SURVEY_RESULT (discussed further below) that are encoded in the customer signature being classified. Additionally or alternatively, in some implementations, the neural network 218 may be weighted in favor of classifying, in the re-engage category, customers who appeared serious about making a purchase during the initial engagement. How serious was a customer about making a purchase can be inferred by the neural network 218 from the values of labels, such as QUOTES_DISCUSSED or CUSTOMER_CALL (discussed further below) that are encoded in the customer signature being classified. In some implementations, the neural network 218 may be weighted in favor of classifying, in the re-engage category, customers who appeared interested in making high-value purchases, even if the customers do not appear to have been in a good mood during the initial engagement or did not exhibit a strong interest in making a purchase. In some implementations, the neural network 218 may be weighted against classifying, in the re-engage category, customers who have already been re-engaged following the initial engagement. Whether a customer has been re-engaged may be inferred by the neural network 218 from the values of labels, such as CUSTOMER_CONTACTED (discussed further below).

The processor 212 may be configured to execute a rule-based engine 220. The rule-based engine 220 may be configured to execute one or more rules for determining the values of a label (or a plurality of labels). In some implementations, the rule-based engine 220 may evaluate one or more rules (for determining the value of a label) by relying on information that is stored in only one of the databases 122-129. Additionally or alternatively, in some implementations, the rule-based engine 220 may evaluate one or more rules (for determining the value of a label) by cross-referencing information that is stored in only one of the databases 122-129.

The rule-based engine 220 may be also used to identify customers who match a particular customer profile. A customer profile may consist of one or more customer characteristics. A customer is said to match a customer profile if the customer possesses the characteristics. A customer may not match the profile if the customer does not possess the characteristics. In some implementations, a customer profile may be associated with a marketing (or re-engagement) campaign, and it may specify a particular type of customer who is targeted by the campaign. In such implementations, the rule-based engine 220 may be used to identify a plurality of customers who match the profile, and the neural network 218 may classify the customer signatures for the identified customers to determine if they should be contacted (or re-engaged)

An example of a customer profile includes “customers who received a quote on laptops, who did not complete the quoted purchase, and who responded positively to a survey.” Another example of a customer profile may include “business-to-business customers who did not respond positively to a survey, but who obtained a quote on a product having a high-profit margin.” Additionally or alternatively, in some implementations, a customer profile may be specified in terms of the values of one or more labels. For example, a customer profile may be specified as follows: “CUSTOMER_OPTIN=1; QUOTES_DISCUSSED = 1; ORDER_CREATED = 0;”. In such implementations, the rule-based engine 220 may perform a search of the metadata database 110 to identify customers who are associated with labels having the values specified by the profile. Specifically, in response to the profile of the present example, the rule-based engine 220 may identify (i) only customers that are associated with all the label types identified in the profile, and (ii) for whom the label types have the values specified the profile. So, if a customer is not associated with a CUSTOMER_OPTIN label, the customer would not be considered to match the profile. Similarly, if a customer is associated with a CUSTOMER_OPTIN label, but the value of the label is ‘0’, the customer would also not be considered to match the profile.

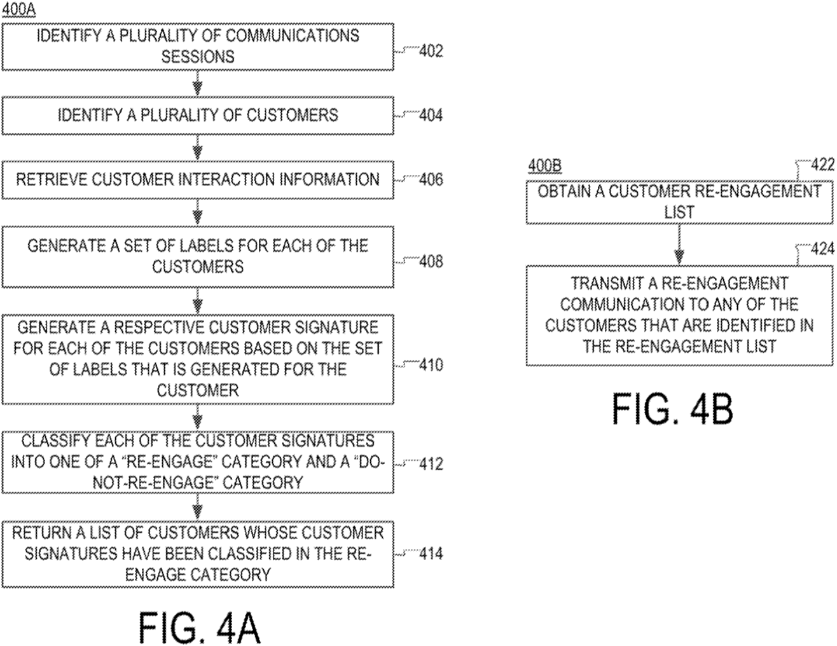

The processor 212 may be configured to execute a lead manager 221. In some implementations, the lead manager 221 may be configured to execute a process 400A, which is discussed with respect to FIG. 4A. Additionally or alternatively, in some implementations, the lead manager 221 may be configured to populate the metadata database 110 with label sets for different customers. In some implementations, the lead manager 221 may update the metadata database 110 periodically. For example, the lead manager 221 may identify communications sessions involving customers, which were conducted since the last time the metadata database 110 was updated. For each of the customers who were involved in such a communication session, the lead manager 221 may generate a label set by executing one or more of the neural networks 217 or the rule-based engine 220. Next the lead manager 221 may store each of the label sets in the metadata database 110. Next the lead manager 221 may generate a respective customer signature based on each of the label sets. Finally, the lead manager may classify the customer signature by executing the neural network 218.

In another aspect, the lead manager 221 may operate as a search engine for identifying customers who are likely to respond positively to a re-engagement attempt (e.g., by making a purchase). For example, the lead manager 221 may receive a request for re-engagement leads, and return a re-engagement list in response. The re-engagement list may be generated by classifying customer signatures with the neural network 218. Additionally or alternatively, in some implementations, the lead manager 221 may be configured to identify customers who match a particular profile (by using the rule-based engine 220), and return a customer re-engagement list that identifies customers who match the profile and whose signatures have been classified in the “re-engage category”.

In some implementations, the lead manager 221 may be configured to execute a first process, a second process, and a third process. The first, second, and third processes may be executed in parallel or sequentially.

The first process may: (i) scan the databases 120 to identify communications sessions that have been conducted since the last execution of the process; (ii) obtain a transcript of each of the communications sessions; (iii) for each of the communications sessions, obtain other customer engagement information if such is available, (iv) for each of the communications sessions, generate one or more labels (such as the labels discussed below) based on the transcript of the communications session and the customer engagement information for the communications session, and (v) for each of the communications sessions, store the labels in a database, such as the metadata database 110, in manner in which they are keyed to an identifier of the customer who participated in the communications session or an identifier of the communications session. Any of the labels may be the same or similar to the labels discussed further below. However, the present disclosure is not limited to any specific type of label being generated.

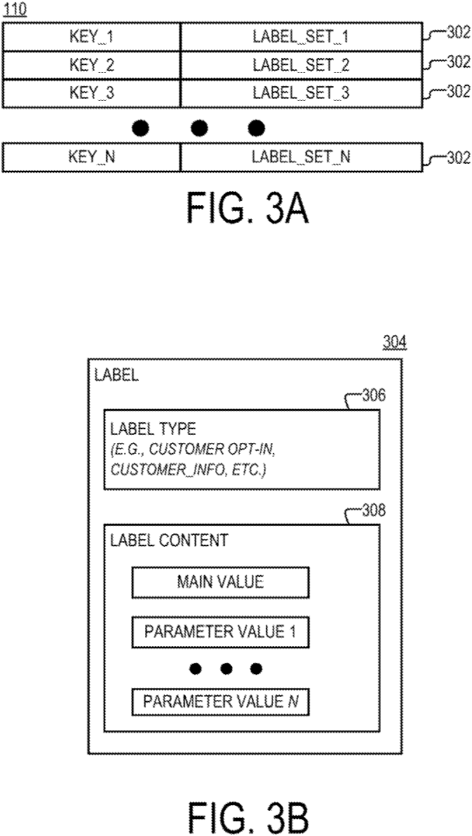

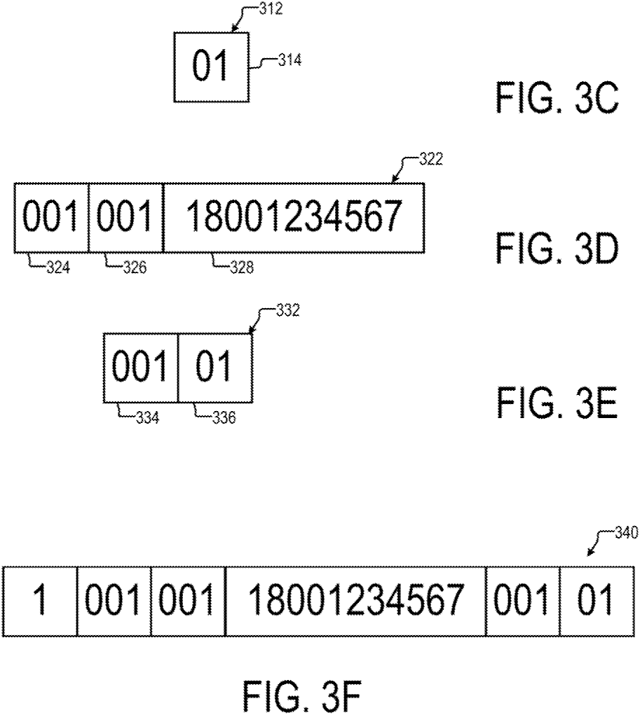

The second process may: (i) scan the metadata database for new sets of labels that have been added to the metadata database by the first process, (ii) for each communications session, generate a customer signature (for the customer who participated in the communications session) based on all (or some) of the labels that are stored in the metadata database for this communications session, and (iii) and store the generated signature in the metadata database (or another database). Each customer signature may be generated in the manner discussed further below with respect to FIG. 3F.

The third process may: (i) receive a request to provide a customer re-engagement list, (ii) identify a plurality of customer signatures that have been generated by the second process, (iii) classify, with the neural network 218, each of the signatures into one of a re-engage category and do-not-re-engage category, and (iv) return, in response to the request, identifiers of customers whose signatures have been classified in the re-engage category.

In some implementations, the generation of labels by the first process may constitute pre-processing of raw customer engagement data that is generated in an enterprise network. To illustrate the scale of the work performed by the first process, if executed every week, in a large company, the first process may generate around 1.5 million rows of data. Although in the present example, the first, second, and third processes are performed by the lead manager 221, alternative implementations are possible in which they are implemented as microservices.

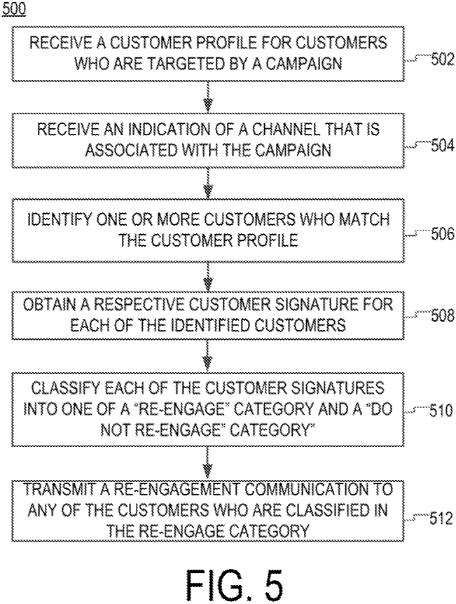

Additionally or alternatively, in some implementations, the lead manager 221 may be configured to execute at least a portion of the process 400A, which is discussed further below with respect to FIG. 4A. Additionally or alternatively, in some implementations, the lead manager 221 may be configured to execute at least a portion of the process 500, which is discussed further below with respect to FIG. 5.

The memory 224 may be configured to store the metadata database 110. Although in the example of FIG. 2 the metadata database 110 is stored in the memory 224, alternative implementations are possible in which the metadata database 110 is stored externally from the system 108. As noted above, the metadata database 110 may be stored on one or more dedicated servers that are connected to the system 108 via the communications network 106.

FIG. 3A is a diagram of the metadata database 110, according to aspects of the disclosure. According to the example of FIGS. 3, the metadata database 110 may include entries 302. Each entry 302 may include a respective key and a respective set of labels. The key in each entry 302 may include one or both of: (i) an identifier of a communications session that is associated with the entry 302 and/or (ii) an identifier of a customer who participated in the communications session (e.g., IP address, MCMID, username, etc.). The labels in each entry 302 may include one or more labels that are associated with: (i) the customer who participated in the entry’s 302 corresponding communications session and/or (ii) the information that was exchanged during the communications session. In other words, each of the labels in a given entry 302 may indicate (i) whether a particular condition was satisfied by the communications session associated with the entry, and/or (ii) the manner in which the condition was satisfied. In some implementations, any of the label sets stored in database 110 may include one or more of the labels discussed further below. However, the present disclosure is not limited to any specific type of label being used.

FIG. 3B is a diagram of a data structure 304 that can be used to represent any of the labels discussed above with respect to FIG. 3A. As illustrated, the data structure may include a label type identifier 306 and label content 308. The label content 308 may include the main value of the label. Optionally, the label content 308 may include the values of one or more parameters of the label as well. FIG. 3C is a diagram of an example of the contents 312 of a first label. In the example of FIG. 3C, the type of the first label is PA_ACCOUNT_SHARED (see example blow) and the contents 312 of the label include only a main value 314. FIG. 3D is a diagram of an example of the contents 322 of a second label. In the example of FIG. 3D, the type of the second label is REDIRECT_CUTOMER (see example below) and the contents 322 of the second label include a main value 324, a first parameter value 326, and a second parameter value 328. FIG. 3E is a diagram of an example of the contents 332 of a third label. In the example of FIG. 3D, the type of the third label is DISCOUNT_DISCUSSED (see example below) and the contents 332 of the third label include a main value 334 and a parameter value 336.

In the example of FIGS. 3C-E, the first, second, and third labels are part of the same label set and are stored in the same entry 302 of the metadata database 110. As such, the first, second, and third labels are associated with the same communications session between a customer and an agent. Moreover, the first, second, and third labels may be considered to be associated with the customer who participated in the communications session (hereinafter “target customer.”)

FIG. 3F shows an example of a customer signature 340 for the target customer. In the example of FIG. 3F, the contents of the first, second, and third labels are concatenated to form the customer signature 340. FIG. 3F is provided to show that a customer signature for a target customer may be generated based on all (or some) labels that are part of a label set associated with a communications session in which the target customer participated. Furthermore, FIG. 3F is provided to illustrate that the customer signature for a target customer may encode the contents (or values) of some (or all) of the labels that are associated with the target customer and/or the communications session in which the customer participated. Although in the example of FIG. 3F the customer signature 340 is generated for concatenating the contents of the labels for the customer, it will be understood that the present disclosure is not limited to any specific way of encoding the label values (e.g., main values and/or parameter values) into a customer signature.

FIG. 4A is a flowchart of an example of a process 400A, according to aspects of the disclosure. In the example of FIG. 4A, the process 400A is performed by the system 108. However, the present disclosure is not limited to any entity or set of entities executing the process 400A.

At step 402, a plurality of communications sessions is identified. Each of the communications sessions may be a communications session that is conducted between a customer and an agent. Any of the communications sessions may include a voice call, a chat session, and/or any other suitable type of communications session. Any of the communications sessions may be performed for the purpose of the customer obtaining information on a product, obtaining a quote, and/or any other reason. Any of the communications sessions may be initiated by either the customer or the agent. In some implementations, only communications sessions that have taken place within predetermined period may be identified (e.g., within the past two weeks or since the last execution of the process 400A). In some implementations, the plurality of communications sessions may be identified by using the database 122.

At step 404, a plurality of customers is identified. Each of the identified customers is a customer who participated in at least one of the communications sessions (identified at step 402).

At step 406, customer interaction information is retrieved for each of the communications sessions (identified at step 402). The customer interaction information may be retrieved from one or more of the databases 120. The customer interaction information for each of the communications sessions may include a transcript of the communications session. In addition, the customer interaction information for any of the communications sessions may optionally include one or more of (i) records of any quotes that were made or discussed during the communications session, (ii) records of any quotes that were given to the customer who participated in the communications session after the communications session was over, (iii) records of any purchase orders that were placed during the communications session, (iv) records of any purchase orders that were placed by the customer who participated in the communications session after the communications session was over, (iv) surveys that are completed by the customer, (vi) and/or any other suitable information.

At step 408, a different set of labels is generated for each of the customers (identified at step 404). The set of labels for any of the customers may include one or more labels, such as the labels discussed below. The set of labels for any of the customers may be generated based on the customer interaction information (retrieved at step 406), and, as such, it is also associated with a communications session involving the customer (identified at step 402). Specifically, the set of labels for each of the customers may include at least one label that is generated based on the transcript of the communications session involving the customer. In some implementations, and of the labels in a label set may be generated as discussed further below.

At step 410, a respective customer signature is generated for each of the customers (identified at step 406). The respective customer signature for any of the customers may be generated based on the set of labels for this customer (obtained at step 408) In some implementations, each respective customer signature may have a format that is the same or similar to that of the customer signature 340, which is discussed above with respect to FIG. 3F. In some implementations, the set of labels used to generate any given one of the customer signatures may include at least some of the labels that are discussed further below. The given customer signature may be generated by concatenating the values (e.g., main values and parameter values) of the labels, and/or otherwise encoding the values of the labels.

At step 412, each of the customer signatures (generated at step 410) is classified into one of a “re-engage” category and a “do-not-re-engage” category. The classification may be performed by using a neural network, such as the neural network 218, which is discussed above with respect to FIG. 2. The classification may be performed in the manner discussed above with respect to FIG. 2.

At step 414, a list is returned that identifies all customers whose signatures are classified in the “re-engage” category. The list may exclude customers whose signatures are classified in the “do not-re-engage” category.

As used throughout the disclosure, the term “list of customers” may refer to one or more identifiers for the customers. The identifiers may be contained in the same data structure (e.g., the same text file or the same binary object). Alternatively, the identifiers may be contained in separate data structures. In this regard, it will be understood that the term “list of customers”, as used herein, shall refer to a “set of one or more customer identifiers,” and is not intended to imply the use of a particular data structure or a set of data structures to represent the list. Similarly, the phrase “returning a list of customers” may refer to any action that results in the identifiers of the customers being returned or communicated. For example, returning the list may include transmitting the identifiers one at a time, transmitting the identifiers to different computing devices, transmitting a data structure that encapsulates all of the identifiers, etc. In some implementations, the transmission may be performed over a communications network, such as the communications network 106, to an entity, such as the system 109. As another example, returning the list may include displaying the identifiers one at a time, displaying the identifiers on different computing devices, displaying a text file that includes the customer identifiers, etc.

FIG. 4B is a flowchart of an example of a process 400B, according to aspects of the disclosure. In the example of FIG. 4B, the process 400B is performed by the re-engagement system 109. However, the present disclosure is not limited to any entity or set of entities executing the process 400B.

At step 422, the re-engagement system 109 obtains a customer re-engagement list. The customer re-engagement list may be obtained from the lead identification system 108. The customer re-engagement list may be received from the system 108 in response to a request transmitted by the system 109. The customer re-engagement list may be the same or similar to the list returned at step 414 of the process 400A. In some implementations, the customer re-engagement list may be generated by executing the process 400A, which is discussed above with respect to FIG. 4A.

At step 424, the re-engagement system 109 transmits a re-engagement communication to each (or at least some) of the customers identified in the customer re-engagement list. Transmitting a re-engagement communication may include transmitting an SMS message. Additionally or alternatively, transmitting a re-engagement communication may include transmitting an email. Additionally or alternatively, transmitting a re-engagement communication may include transmitting a request to initiate a telephone call or video call (i.e., calling the customer). It will be understood that the present disclosure is not limited to using any specific channel for the transmission of the re-engagement communication. In some implementations, the re-engagement communication may include one or more of a message inviting a customer to purchase a product, a message inviting the customer to make a purchase on a previously-provided quote, a message including a sales quote, an advertisement, and/or any other suitable type of message.

In some implementations, step 424 may be performed only after a human review is performed of the list to confirm that all customers identified in the list are suitable recipients for a re-engagement communication. In some implementations, a re-engagement communication may be sent to fewer than all customers in the list. In some implementations, the system 108 (or another entity) may detect whether a customer has opened a re-engagement communication (or clicked on a link that is provided therein) and record this information in any of the databases 120 for use (by the systems 108 and 109) in subsequent re-engagement campaigns. In some implementations, the system 108 (or another entity) may detect whether a customer has made a purchase in response to a re-engagement communication and record this information in any of the databases 120 for use (by the systems 108 and 109) in subsequent re-engagement campaigns.

FIG. 5 is a flowchart of an example of a process 500 for conducting a targeted campaign, according to aspects of the disclosure.

At step 502, a customer profile is received that is associated with a campaign (e.g., a marketing campaign, a re-engagement campaign, etc. The customer profile may specify one or more customer characteristics. In some implementations, the customer profile may be received from an input device (e.g., a keyboard or microphone). Additionally or alternatively, in some implementations, the customer profile may be received over a communications network. According to the present example, the customer profile specifies the customer characteristics in terms of label types and values for the label types. However, it will be understood that the present disclosure is not limited to any specific format for the customer profile.

At step 504, an indication of a channel that is going to be used by the campaign is received. For example, the indication may identify whether the campaign is going to be conducted by the transmission of SMS messages, or whether the campaign is going to be conducted by using voice calls, etc. In other words, the indication may identify the type of re-engagement messages that are going to be used to conduct the campaign. In some implementations, the indication of the channel may be received in the same message as the customer profile.

At step 506, one or more customers are identified who match the customer profile (received at step 502). The one or more customers can be identified based on label sets for the customers that are stored in a metadata database, such as the metadata database 110.

At step 508, a respective customer signature is obtained (or generated) for each of the customers (identified at step 506). The customer signature for any of the customers may be generated based on the contents of one or more labels that are associated with the customer, and which are stored in a metadata database, such as the metadata database 110. The customer signature for any of the customers may be the same or similar to the customer signature 340, which is discussed above with respect to FIG. 3F.

At step 510, each of the customer signatures (obtained at step 410) is classified into one of a “re-engage” category and a “do-not-re-engage” category. The classification is performed with a neural network, such as the neural network 218. According to the present example, the customer signatures are classified with a neural network that is trained on training data that is associated with (or specific to) one or more of (i) the type of channel that is going to be used by the campaign, and/or (ii) the type of product that is being marketed by the campaign. However, the present disclosure is not limited to any specific type of neural network being used.

At step 512, a re-engagement communication is sent to each (or at least some) of the customers who are classified in the “re-engage” category. In some implementations, the re-engagement communication may be sent only to customers whose signatures are classified in the “re-engage” category (at step 510), such that no re-engagement communications are sent to customers whose signatures are classified in the “do-not-re-engage” category.

In some implementations, steps 502-510 may be performed by the system 108 and step 512 may be performed by the system 109. In some implementations, the customer profile and the indication of a channel may be received from the system 109. In some implementations, the system 108 may provide a customer engagement list to the system 109, and the system 109 may perform step 512 by transmitting a re-engagement communication to each (or at least some) of the customers in the list). The re-engagement list may include only customers who have been classified in the “re-engage” category.

An example is now provided of different label types that may be included in each of the label sets that are stored in the metadata database 110. The label types include: DPA_ACCOUT_SHARED, DBC_TOKEN_SHARED, CREDIT_CARD_SHARED, EMAIL_SHOPPING_CART, COUPON_DISCUSSED, DISCOUNT_DISCUSSED, CUSTOMER_CALL, REDIRECT_CUSTOMER, CUSTOMER_OPT_IN, CUSTOMER_INFO, QUOTES_DISCUSSED, ORDER_CREATED, QTO_ENABLED, QUOTE_VALID, CUSTOMER_MOOD, SURVEY_RESULT, CUSTOMER_CONTACTED, and PRODUCT_DISCUSSED. It will be understood that any of the label sets discussed with respect to FIG. 3A may include some or all of these labels. It will further be understood that the present disclosure is not limited to any specific type of label being used, and as such, it is not limited to the labels provided in this example. The discussion that follows assumes that each of the labels is associated with a communications session between a customer and an agent and provides an example of methods for generating the values of the label based on a transcript of the communications session and/or other customer interaction information. The communications session may be phone call, a video call, a voice call, a text chat, a real-time communications session, a near-real-time communications session, and or any other suitable type of communications session. The transcript may include a chat log, a speech-to-text transcript, and/or any other suitable type of transcript.

PA_ACCOUNT_SHARED is indicative of whether the customer has shared a preferred account (PA) number during the communications session. If a PA number is shared, the value of PA_ACCOUNT_SHARED may be ‘1’. On the other hand, if no PA number is shared, the value of PA_ACCOUNT_SHARED may be ‘0’. In some implementations, the value of the PA_ACCOUNT_SHARED may be determined by classifying a signature for the text transcript with one of the neural networks 217 to determine if the customer has shared his or her PA number with the agent during the communications session. Alternatively, the value of the PA_ACCOUNT_SHARED may be determined by using the rule-based engine 220 to determine whether the transcript contains a particular string (e.g., “please provide your preferred account number”).

DBC_TOKEN_SHARED is indicative of whether, during the communications session, the customer has shared a DBC token during the communications session. If a DBC token is shared, the value of DBC_TOKEN_SHARED may be ‘1’. On the other hand, if no DBC token is shared, the value of DBC_TOKEN_SHARED may be ‘0’. In some implementations, the value of DBC_TOKEN_SHARED may be determined by classifying a signature for the text transcript with one of the neural networks 217 to determine if the customer has shared his or her DBC token with the agent during the communications session. Alternatively, the value of DBC_TOKEN_SHARED may be determined by using the rule-based engine 220 to determine whether the transcript contains a particular string (e.g., “please enter your name and pin”, etc.).

CREDIT_CARD_SHARED is indicative of whether the customer has shared his or her credit card number during the communications session. If a credit card number is shared, the value of CREDIT_CARD_SHARED may be ‘1’. On the other hand, if no credit card number is shared, the value of CREDIT_CARD_SHARED may be ‘0’. In some implementations, the value of CREDIT_CARD_SHARED may be determined by classifying a signature for the text transcript with one of the neural networks 217 to determine if the customer has shared his or her credit card number during the communications session. Additionally or alternatively, the value of the CREDIT_CARD_SHARED may be determined by using the rule-based engine 220 to determine whether the transcript contains a particular string (e.g., “would you like to pay with a credit card”, etc.).

CREDIT_CARD_SHARED may have one additional parameter. The additional parameter may be set to ‘1’ when the credit card number was used to complete a successful payment transaction. The additional parameter may be set to ‘2’ when an attempted credit card transaction with the credit number has failed. The additional parameter may be set to ‘3’ when it is not possible to determine if an attempted credit card transaction with the credit number has failed. The value of the additional parameter may be determined by using a payment database and/or in another similar manner.

EMAIL_SHOPPING_CART is indicative of whether, during the communications session, the agent has requested the customer to send his or her shopping cart via email so that the agent can review products the customer is trying to buy. If the shopping cart is requested to be shared, the value of EMAIL_SHOPPING_CART may be ‘1’. On the other hand, if the shopping cart is not requested to be shared, the value of EMAIL_SHOPPING_CART may be ‘0’. In some implementations, the value of the EMAIL_SHOPPING_CART may be determined by using the rule-based engine 220 to determine whether the transcript contains a particular string (e.g., “can you please email me the shopping cart”). Additionally or alternatively, in some implementations, the value of the EMAIL_SHOPPING_CART may be determined by classifying a signature for the text transcript with one of the neural networks 217 to determine if it contains a request for the shopping cart to be emailed.

COUPON_DISCUSSED is indicative of whether the agent and the customer discussed the availability or use of a discount coupon during the communications session. If no coupons were mentioned, the value of COUPON_DISCUSSED may be ‘0’. On the other hand, if the availability or use of a coupon were discussed, the value of COUPON_DISCUSSED may be ‘1’. In some implementations, the value of the COUPON_DISCUSSED may be determined by using the rule-based engine 220 to determine whether the transcript contains a particular string (e.g., “APPLIED COUPON <NNNN>”). Additionally or alternatively, in some implementations, the value of the COUPON_DISCUSSED may be determined by classifying a signature for the text transcript with one of the neural networks 217 to determine if the use of coupons was discussed.

COUPON_DISCUSSED may have one additional parameter. The additional parameter may be set to ‘1’ when it was the agent who brought up the availability of a coupon. The additional parameter may be set to ‘2’ when it was the customer who brought up the use or availability of a coupon. The value of the additional parameter may be determined by classifying a signature of the text transcript with one of the neural networks 217. In the present example, the value of COUPON_DISCUSSED is indicative of whether a particular condition is satisfied, and the value of the additional parameter indicates on whose initiative was the condition satisfied -i.e., whether the condition was satisfied as a result of the agent offering information about available coupons without prompt from the customer or as a result of the customer asking if any coupons are available (e.g., without being encouraged to request a discount by the agent).

DISCOUNT_DISCUSSED is indicative of whether the agent and the customer discussed the availability or use of customer discounts during the communications session. If no coupons were discussed, the value of DISCOUNT_DISCUSSED may be ‘0’. If the availability of a generic discount is mentioned, the value of DISCOUNT_DISCUSSED may be ‘1’. If the availability of a student discount is mentioned, the value of DISCOUNT_DISCUSSED may be ‘2’. If the availability of a veteran’s discount is mentioned, the value of DISCOUNT_DISCUSSED may be ‘3’. In some implementations, the value of the DISCOUNT_DISCUSSED may be determined by using the rule-based engine 220 to determine whether the transcript contains a particular string (e.g., “are there any discounts available”). Additionally or alternatively, in some implementations, the value of the DISCOUNT_DISCUSSED may be determined by classifying a signature for the text transcript with one of the neural networks 217 to determine if the use of discounts was discussed.

DISCOUNT_DISCUSSED may have one additional parameter. The additional parameter may be set to ‘1’ when it was the agent who brought up the availability of a discount. The additional parameter may be set to ‘2’ when it was the customer who brought up the use or availability of a discount. The value of the additional parameter may be determined by classifying a signature of the text transcript with one of the neural networks 217. In the present example, the value of DISCOUNT_DISCUSSED is indicative of whether a particular condition is satisfied, and the value of the additional parameter indicates on whose initiative was the condition satisfied -i.e., whether the condition was satisfied as a result of the agent offering information about discounts (e.g., without being prompted by the customer) or as a result of the customer requesting information about discounts (e.g., without being prompted by the agent).

CUSTOMER_CALL provides information about whether a phone call or a callback call was mentioned during the communications session. The CUSTOMER_CALL label may be used when the communications session is a text chat, and it may be indicative of whether there were any attempts to make the interaction with the customer more personal. If no phone calls were mentioned, the value of CUSTOMER_CALL may be ‘0’. If the conduct of a phone call was mentioned, the value of CUSTOMER _CALL may be ‘1’. If a callback was mentioned outside of the context of a disconnect, the value of CUSTOMER_CALL may be ‘2’. If a callback was discussed only in the context of an unexpected disconnect, the value of CUSTOMER_CALL may be ‘3’. In some implementations, the value of the CUSTOMER_CALL may be determined by using the rule-based engine 220 to determine whether the transcript contains a particular string (e.g., “can you call me please, my phone number is”). Additionally or alternatively, in some implementations, the value of the CUSTOMER_CALL may be determined by classifying a signature for the text transcript with one of the neural networks 217 to determine if a phone call or a callback was discussed.

CUSTOMER_CALL may have one additional parameter. The additional parameter may be set to ‘1’ when the agent offered to call the customer. The additional parameter may be set to ‘2’ when the customer asked to be called. The additional parameter may be set to ‘3’ when the agent asked to call the customer, but the customer declined. The value of the additional parameter may be determined by classifying a signature of the text transcript with one of the neural networks 217. In the present example, the value of CUSTOMER_CALL is indicative of whether a particular condition is satisfied, and the value of the additional parameter indicates on whose initiative was the condition satisfied - i.e., whether the condition was satisfied as a result of the agent suggesting a callback or as a result of the customer making a request for a callback.

REDIRECT_CUSTOMER indicates whether the customer was redirected by the agent. If the customer was redirected, the value of REDIRECT_CUSTOMER may be ‘1’. If the customer was not redirected, the value of REDIRECT_CUSTOMER may be ‘0’. REDIRECT_CUSTOMER may have a first additional parameter and a second additional parameter. The value of the first additional parameter may identify an entity, which the customer was redirected to. For example, the first additional parameter may be ‘1’ if the customer was redirected to customer care, ‘2’ if the customer was redirected to tech support, ‘3’ if the customer was redirected to direct finance services, and ‘4’ if the customer was redirected to all other departments. The value of the second additional parameter may be a telephone number (or another far-end party identifier), to which the customer was redirected.

CUSTOMER_OPTIN indicates whether the agent requested the customer to give permission to be contacted in the future. If no request was made to give permission, the value of CUSTOMER_OPTIN may be ‘0’. If a request to give permission was made, the value of CUSTOMER_OPTIN may be ‘1’. In some implementations, the value of the CUSTOMER_OPTIN may be determined by using the rule-based engine 220 to determine whether the transcript contains a particular string (e.g., “Do you accept receiving follow-up SMS messages related to this conversation on the mobile phone number <NNNN>”?”). Additionally or alternatively, in some implementations, the value of the CUSTOMER_OPTIN may be determined by classifying a signature for the text transcript with one of the neural networks 217 to determine if permission was requested from the customer.

CUSTOMER_OPTIN may have one additional parameter. The additional parameter may be set to ‘-1’ when the agent requested permission, but the response of the customer cannot be identified. The additional parameter may be set to ‘0’ when the agent requested permission, but the customer denied the request. The additional parameter may be set to ‘2’ when the agent requested permission, and the customer granted the permission. CUSTOMER_OPTIN is an example of a class of labels whose main value indicates whether an agent performed a particular action, and whose parameter value indicates the response of the customer to the action.

CUSTOMER_INFO indicates whether the agent requested one or more items of detailed customer information (e.g., customer email address, billing information, etc.) during the communications session. If no such information was requested, the value of CUSTOMER_INFO may be ‘0’. If a request was made for such information, the value of CUSTOMER_INFO may be ‘1’. In some implementations, the value of the CUSTOMER_INFO may be determined by using the rule-based engine 220 to determine whether the transcript contains a particular string (e.g., “In order to create a quote for you, I would require your full name, billing, and shipping address, email address and your phone number, please?”, etc.). Additionally or alternatively, in some implementations, the value of the CUSTOMER_INFO may be determined by classifying a signature for the text transcript with one of the neural networks 217.

CUSTOMER_INFO may have a first additional parameter and a second parameter. The first additional parameter may be set to ‘0’ if the information was requested for the purpose of creating a quote. The first additional parameter may be set to ‘1’ if the information was requested for the purpose of creating an order. The first additional parameter may be set to ‘2’ if the information was requested for the purpose of creating a user profile. The first additional parameter may be set to ‘3’ if the information was requested for the purpose of verifying the identity of the customer. The first additional parameter may be set to ‘4’ if it is not possible to determine the reason for which the information was requested. In some implementations, the value of the first additional parameter may be obtained by classifying a signature of the transcript with one of the neural networks 217. The second additional parameter may include the information that was provided by the customer in response to the request (e.g., name, email, etc.). CUSTOMER_INFO is an example of a label that is indicative of whether a particular type of information was provided during a communications session and the first additional parameter is an example of an indication of the purpose for which the information was requested. The first additional parameter may be determined by classifying a signature of the text transcript with one of neural networks 217.

QUOTES_DISCUSSED indicates whether the agent and the customer discussed a quote for the purchase of a product. According to the present example, QUOTES_DISCUSSED indicates whether quotes were discussed during the communications session only. However, alternative implementations are possible, in which QUOTES DISCUSSED indicates whether quotes were discussed during the communications session and a predetermined period after the communications session (e.g., in the next 24 hours). If a quote was discussed, the value of QUOTES_DISCUSSED may be ‘0’. If a quote was not discussed, the value of QUOTES_DISCUSSED may be ‘1’. In some implementations, the value of the QUOTES_DISCUSSED may be determined by using the rule-based engine 220 to determine whether the transcript contains a particular string (e.g., “Can you give me a quote”, etc.). Additionally or alternatively, in some implementations, the value of the QUOTES_DISCUSSED may be determined by classifying a signature for the text transcript with one of the neural networks 217.

QUOTES_DISCUSSED may have a first additional parameter and a second parameter. The first additional parameter may be set to ‘1’ if a quote was mentioned by the agent or customer during the communications session, but the agent did not follow through on creating the quote. The first additional parameter may be set to ‘1’, if a quote was discussed during the communications session, and the agent followed through on creating the quote. In some implementations, the value of the first additional parameter may be determined, by the rule-based engine 220, based on whether the quotes database 124 includes a quote for the customer whose timestamp matches the time when the communications session is conducted. The second additional parameter may include an identifier corresponding to the quote (e.g., a quote number).

Additionally or alternatively, in some implementations, the QUOTES_DISCUSSED label may include a parameter that indicates whether the quote was created by the agent who participated in the communications session or by another agent. Additionally or alternatively, in some implementations, the QUOTES_DISCUSSED label may include a parameter that indicates whether the quote was created during the communications session or after. Additionally or alternatively, in some implementations, the QUOTES_DISCUSSED label may include a parameter that indicates how long after the communications session the quote was created.

ORDER_CREATED, according to the present example, indicates whether the customer placed an order during the communications session. However, alternative implementations are possible in which ORDER_CREATED indicates whether the customer placed an order during the communications session and within a predetermined period after the communications session (e.g., within the next 24 hours). If no order was placed, the value of ORDER_CREATED may be ‘0’. If an order was placed, the value of ORDER CREATED may be ‘1’. In some implementations, the value of the ORDER_CREATED may be determined by using the rule-based engine 220 to determine whether the transcript contains a particular string (e.g., “Can you give me a quote”, etc.). Additionally or alternatively, in some implementations, the value of the ORDER_CREATED may be determined by classifying a signature for the text transcript with one of the neural networks 217.

ORDER_CREATED may have a first additional parameter and a second parameter. The first additional parameter may be set to ‘1’ if the order was completed successfully. The first additional parameter may be set to ‘2’ if the order was created, but there was an issue with the payment, which prevented the order from being completed successfully. The first additional parameter may be set to ‘3’ if the order was created, but it is impossible to confirm whether the order was completed. In some implementations, the value of the first parameter may be determined by the rule-based engine 220 based on information that is stored in the orders database 126. The value of the second additional parameter may include one or more of an order number for the order or a customer number that is associated with the order. The value of the first and/or second additional parameters may be determined by the rule-based engine 220 based on information that is stored in the orders database 126 and/or any other one of the databases 120.

In some implementations, the ORDER_CREATED label may relate the transcript of the communications session with orders found in the orders database 126. the ORDER_CREATED label may be created by scanning the database 126 for orders that are associated with the customer’s email, name (or another identifier, etc). Additionally or alternatively, in some implementations, the ORDER_CREATED label may include a parameter that indicates whether the order was created by the agent who participated in the communications session or by another agent. Additionally or alternatively, in some implementations, the ORDER_CREATED label may include a parameter that indicates whether the order was created during the communications session or after. Additionally or alternatively, in some implementations, the ORDER_CREATED label may include a parameter that indicates how long after the communications session the order was created.

QTO_ENABLED indicates whether a QTO feature is enabled for a selected quote that is made to the customer (e.g., during the communications session). In a customer signature, the contents of QTO_ENABLED and QUOTE_DISCUSSED that are used to generate the customer signature (if at all) may relate to the same quote. The QTO feature may be configured to send the customer a link, which when activated by the customer, takes the customer to a website (or another portal) where the customer can review the details of the quote, and make a purchase based on the quote. The QTO feature may not be enabled for all quotes, and the QTO_ENABLED label enables easy identification of whether the QTO feature is enabled. If the QTO feature is enabled for the selected quote (or is compatible with the quote), the value of QTO_ENABLED may be ‘1’.

QTO_ENABLED may have a first additional parameter and a second parameter. The first additional parameter may be set to ‘0’ if the selected quote is not the latest version of a quote that is provided to the customer. The first additional parameter may be set to ‘1’ if the selected quote is expired. The first additional parameter may be set to ‘2’ if the QTO feature is disabled for a company number of the customer. The first additional parameter may be set to ‘3’ if the selected quote is not a DSA quote. The first additional parameter may be set to ‘4’ if the selected quote is already ordered. The first additional parameter may be set to ‘5’ if an API of the QTO feature is not compatible with the selected quote. The second parameter may include a link for the selected quote - i.e., a link which when activated takes the customer to a website or portal where the customer can review the quote and/or purchase the product that is quoted.

QUOTE_VALID indicates whether a quote given to the customer (e.g., during the communications session) is still valid. In a customer signature, the contents of QTO_VALID and QUOTE_DISCUSSED that are used to generate the customer signature (if at all) may relate to the same quote. A quote may expire for various reasons, such as the quoted product running out of stock or an increase in the price of the quoted product. If the selected quote is invalid, QUOTE_VALID may be equal to ‘0’. If the quote is still valid, QUALITY_VALID may be equal to ‘1’. QUOTE_VALID may have an additional parameter that indicates the severity of the problem that causes the selected quote to be invalid.

QUOTE_VALID may have a first additional parameter and a second parameter. The first additional parameter may be set to ‘0’ if the selected quote is not the latest version of a quote that is provided to the customer. The first additional parameter may be set to ‘1’ if the selected quote is expired. The first additional parameter may be set to ‘2’ if the QTO feature is disabled for a company number of the customer. The first additional parameter may be set to ‘3’ if the selected quote is not a DSA quote. The first additional parameter may be set to ‘4’ if the selected quote is already ordered. The first additional parameter may be set to ‘5’ if an API of the QTO feature is not compatible with the selected quote. The second parameter may include a link for the selected quote - i.e., a link which when activated takes the customer to a website or portal where the customer can review the quote and/or purchase the product that is quoted.

CUSTOMER_MOOD may indicate identify a sentiment exhibited by the customer during the communications session. CUSTOMER_MOOD may be equal to ‘0’ if the customer exhibited a negative sentiment, ‘1’ if the customer exhibited a neutral sentiment, and ‘2’ if the customer exhibited a positive sentiment. The value of CUSTOMER_MOOD may be determined by classifying a signature of the transcript with one of neural networks 217.

SURVEY_RESULT may indicate identify the type of feedback provided by the customer in a survey regarding the communications session. SURVEY_RESULT may be equal to ‘0’ if the customer provided negative feedback, ‘1’ if the customer provided a neutral sentiment, and ‘2’ if the customer provided positive feedback. The value of SURVEY_RESULT may be determined by evaluating one or more rules with the rule-based engine 220 or by classifying a signature of the survey with one of the neural networks 217. The signature of the survey may be obtained from the surveys database 129.

CUSTOMER_CONTACTED may indicate whether the customer was re-engaged after the communications session. CUSTOMER_CONTACTED may be equal to ‘0’ if the customer has not been re-engaged yet, and ‘1’ if the customer has already been re-engaged. The value of CUSTOMER_CONTACTED may be determined based on information that is stored in the database 128.

PRODUCT_DISCUSSED may identify a product that was discussed during the communications session. PRODUCT_DISCUSSED may be equal to ‘1’ if a first product was discussed, ‘2’ if a second product was discussed, ‘3’ if a third product was discussed, and so forth. The value of CUSTOMER_CONTACTED may be determined by classifying a signature of the survey with one of the neural networks 217.

In the examples provided above, each label includes a “value” and one or more additional parameters. The value of each parameter may correspond to the box labeled “main value”, which is shown in FIG. 3B and the parameter values correspond to the boxes labeled “parameter value N”, which are also shown in FIG. 3B. In some implementations, the information represented by the main value and the parameter values of a label may be represented by a single number (or alphanumerical string). In some implementations, the additional parameter of any label may have a default value, when not applicable. For example, the additional parameter of CREDIT_CARD_SHARED may be set to ‘0’ when no credit card number is provided by a customer. In some implementations, any of the neural networks 217 that is used to determine the value of a label may include a neural network that is configured to classify a signature of the transcript of the communications session into one of a plurality of states, wherein each possible value of the label corresponds to a different one of the plurality of states. In some implementations, any of the neural networks 217 that is used to determine the value of an additional parameter may include a neural network that is configured to classify a signature of the transcript of the communications session into one of a plurality of states, wherein each possible value of the additional parameter corresponds to a different one of the plurality of states. The examples above, discuss classifying a signature of a communications session transcript to determine the value of various labels or additional parameters. It will be understood that the classified signature may be based exclusively on the communications session transcript or it can be also based on other information that is retrieved from any of the databases 120.

Referring to FIG. 6, computing device 600 may include processor 602, volatile memory 604 (e.g., RAM), non-volatile memory 606 (e.g., a hard disk drive, a solid-state drive such as a flash drive, a hybrid magnetic and solid-state drive, etc.), graphical user interface (GUI) 608 (e.g., a touchscreen, a display, and so forth) and input/output (I/O) device 620 (e.g., a mouse, a keyboard, etc.). Non-volatile memory 606 stores computer instructions 612, an operating system 616 and data 618 such that, for example, the computer instructions 612 are executed by the processor 602 out of volatile memory 604. Program code may be applied to data entered using an input device of GUI 608 or received from I/O device 620.

Processor 602 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard-coded into the electronic circuit or soft coded by way of instructions held in a memory device. A “processor” may perform the function, operation, or sequence of operations using digital values or using analog signals. In some embodiments, the “processor” can be embodied in an application-specific integrated circuit (ASIC). In some embodiments, the “processor” may be embodied in a microprocessor with associated program memory. In some embodiments, the “processor” may be embodied in a discrete electronic circuit. The “processor” may be analog, digital or mixed-signal. In some embodiments, the “processor” may be one or more physical processors or one or more “virtual” (e.g., remotely located or “cloud”) processors.

FIGS. 1-6 are provided as an example only. At least some of the steps discussed with respect to FIGS. 1-6 may be performed in parallel, performed in a different order, or altogether omitted. Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary.*. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
identifying, by one or more processors, a plurality of communications sessions and obtaining a respective text transcript of each of the plurality of communications sessions, each of the plurality of communications sessions being a communications session in which a respective one of a plurality of customers is a participant;
generating, by the one or more processors, a plurality of label sets, each of the label sets corresponding to a different one of the plurality of customers, each of the plurality of label sets being generated based, at least in part, on the respective text transcript of one of the plurality of communications sessions in which the label set’s corresponding customer is a participant;
generating, by the one or more processors, a plurality of customer signatures, each of the plurality of customer signatures being generated based on a different one of the plurality of label each of the customer signatures including a plurality of portions, each of the portions being indicative of contents of a different label in the label set that is used to generate the customer signature;
classifying, by the one or more processors, each of the plurality of customer signatures into one of a “re-engage” category and a “do-not-re-engage” category, the classification being performed by using a first neural network; and
returning, by the one or more processors, a customer re-engagement list that identifies respective ones of the plurality of customers who are associated with customer signatures that are classified in the “re-engage” category.

2. The method of claim 1, further comprising transmitting a re-engagement communication to any of the customers that are identified in the customer re-engagement list.

3. The method of claim 1, wherein the respective label set for any given one of the plurality of customers includes a label that indicates: (i) whether a condition is satisfied by the given customer, and (ii) whether the condition is satisfied on the initiative of the given customer or on the initiative of an agent, the label being generated, at least in part, by using a second neural network.

4. The method of claim 1, wherein the respective label set for any given one of the plurality of customers includes a label that indicates: (i) whether a condition is satisfied by the given customer, and (ii) whether the condition is satisfied on the initiative of the given customer or on the initiative of an agent.

5. The method of claim 1, wherein classifying any of the plurality of customer signatures into one of a “re-engage” category and a “do-not-re-engage” category includes:
classifying the customer signature, with the first neural network, into one of a plurality of categories, the plurality of categories including one or more first categories and one or more second categories;
when the customer signature is classified in any of the first categories, determining that the customer signature is classified into the “re-engage” category; and
when the customer signature is classified in any of the second categories, determining that the customer signature is classified into the “do-not-re-engage” category.

6. The method of claim 1, wherein the re-engage category includes a category associated with a heightened customer potential for completing a purchase.

7. The method of claim 1, wherein at least one of the plurality of label sets includes a label that is indicative of at least one of: (i) whether a predetermined subject was discussed during the communications session whose text transcript is used as a basis for generating the label set, or (ii) whether a particular action was performed by the customer during the communications session whose text transcript is used as a basis for generating the label set.

8. A system, comprising:
a memory; and
at least one processor that is operatively coupled to the memory, the at least one processor being configured to perform the operations of:
identifying a plurality of communications sessions and obtaining a respective text transcript of each of the plurality of communications sessions, each of the plurality of communications sessions being a communications session in which a respective one of a plurality of customers is a participant;
generating a plurality of label sets, each of the label sets corresponding to a different one of the plurality of customers, each of the plurality of label sets being generated based, at least in part, on the respective text transcript of one of the plurality of communications sessions in which the label set’s corresponding customer is a participant;
generating a plurality of customer signatures, each of the plurality of customer signatures being generated based on a different one of the plurality of label sets, each of the customer signatures including a plurality of portions, each of the portions being indicative of contents of a different label in the label set that is used to generate the customer signature;
classifying each of the plurality of customer signatures into one of a “re-engage” category and a “do-not-re-engage” category, the classification being performed by using a first neural network; and
returning a customer re-engagement list that identifies respective ones of the plurality of customers who are associated with customer signatures that are classified in the “re-engage” category.

9. The system of claim 8, wherein the at least one processor is further configured to perform the operation of transmitting a re-engagement communication to any of the customers that are identified in the customer re-engagement list.

10. The system of claim 8, wherein the respective label set for any given one of the plurality of customers includes a label that indicates: (i) whether a condition is satisfied by the given customer, and (ii) whether the condition is satisfied on the initiative of the given customer or on the initiative of an agent, the label being generated, at least in part, by using a second neural network.

11. The system of claim 8, wherein the respective label set for any given one of the plurality of customers includes a label that indicates: (i) whether a condition is satisfied by the given customer, and (ii) whether the condition is satisfied on the initiative of the given customer or on the initiative of an agent.

12. The system of claim 8, wherein classifying any of the plurality of customer signatures into one of a “re-engage” category and a “do-not-re-engage” category includes:
classifying the customer signature, with the first neural network, into one of a plurality of categories, the plurality of categories including one or more first categories and one or more second categories;
when the customer signature is classified in any of the first categories, determining that the customer signature is classified into the “re-engage” category; and
when the customer signature is classified in any of the second categories, determining that the customer signature is classified into the “do-not-re-engage” category.

13. The system of claim 8, wherein the re-engage category includes a category associated with a heightened customer potential for completing a purchase.

14. The system of claim 8, wherein at least one of the plurality of label sets includes a label that is indicative of at least one of: (i) whether a predetermined subject was discussed during the communications session whose text transcript is used as a basis for generating the label set, or (ii) whether a particular action was performed by the customer during the communications session whose text transcript is used as a basis for generating the label set.

15. A method comprising:
retrieving, by one or more processors, customer interaction information that is associated with a customer, the customer interaction information including a text transcript of a communications session in which the customer is a participant;
generating, by the one or more processors, a plurality of labels for the customer based on the customer interaction information, at least one of the plurality of labels being generated based on the text transcript of the communications session;
generating, by the one or more processors, a customer signature for the customer, the customer signature being generated based on the plurality of labels, the customer signature including a plurality of portions, each of the portions being indicative of contents of a different one of the plurality of labels; and
classifying, by the one or more processors, the customer signature into one of a plurality of categories, the plurality of categories including one or more first categories and one or more second categories, the classification being performed, at least in part, by using a first neural network; and
transmitting, by the one or more processors, a re-engagement communication to the customer based on an outcome of the classification of the customer signature for the customer, the re-engagement communication being transmitted only when the customer signature is classified into the one or more first categories.

16. The method of claim 15, wherein the plurality of labels includes a label that indicates: (i) whether a condition is satisfied by the customer, and (ii) whether the condition is satisfied on the initiative of the customer or on the initiative of an agent, the label being generated, at least in part, by using a second neural network.

17. The method of claim 15, wherein the plurality of labels includes a label that indicates: (i) whether a condition is satisfied by the customer, and (ii) whether the condition is satisfied on the initiative of the customer or on the initiative of an agent.

18. The method of claim 15, wherein the customer is selected based on the customer matching a customer profile that is associated with a marketing campaign.

19. The method of claim 15, wherein the one or more first categories are associated with a heightened customer potential for completing a purchase.

20. The method of claim 15, wherein the first neural network is trained based on a training data set, the training data set including a plurality of training data items, each training data item including: (i) a customer signature and (ii) a training label that is generated based on whether a customer associated with the customer signature has completed a purchase following a past re-engagement communication to the customer.
